(19) United States
(12) Patent Application Publication
(10) Pub. No.: US 2015/0314824 A1
(43) Pub. Date: Nov. 5, 2015

(54) Skid Plate for the 2013+ BMW R 1200 GS

(71) Applicant: Jeremy LeBreton, Seattle, WA (US)

(72) Inventor: Jeremy LeBreton, Seattle, WA (US)

(21) Appl. No.: 14/269,434

(22) Filed: May 5, 2014

(51) Int. Cl. B62J 23/00; B62J 27/00

(52) U.S. Cl. CPC B62J 23/00; B62J 27/00

(57) ABSTRACT

A protection system designed specifically for use on the 2013 to current BMW R 1200 GS motorcycle. This system is comprised of an aluminum skid plate and stainless steel mounting brackets. The aluminum skid plate is unique in that it does not mount directly to the cast aluminum engine block in the rear. This prevents force of an impact from being transferred to the motor.

### BACKGROUND OF THE INVENTION

1. Technical Field of the Invention

This invention relates to motorcycles, and more specifically the 2013 to current BMW R 1200 GS (Internal BMW model number K50).

2. Description of the Prior Art

The BMW R 1200 GS motorcycle is commonly ridden in technical riding situations in which low traction, uneven riding surfaces, difficult to manage angles or other factors greatly increase the chance of dropping and/or crashing the motorcycle. The BMW R 1200 GS is particularly vulnerable to damage caused by impacts to the bottom of the motor. While there are a number of designs available that seek to minimize this damage, there are inherent issues in the ways these designs provide protection and mount to the BMW R 1200 GS motorcycle.

### SUMMARY OF THE INVENTION

The invention in its broadest aspect includes an aluminum skid plate that mounts directly to the BMW R 1200 GS motorcycle. The invention's particular design, mounting methods and manufacturing methods are inherent in aiding in the prevention of damage to the BMW R 1200 GS motorcycle in the event of a low-speed drop, or impact against obstacles on the road or trail. Fully fueled and without a rider, the BMW R 1200 GS weighs 524 pounds. This weight combined with the speed of riding can easily cause the motorcycle to bottom out on obstacles—potentially damaging the engine case.

The aluminum skid plate provides protection from road and trail debris from the front of the motor to past the center stand mount. The aluminum skid plate is mounted utilizing the stainless steel brackets, and custom threaded aluminum pins that replace the OEM center stand mounting bolts. The aluminum skid plate, bracketry and sub-assemblies do not mount directly to the rear of engine case. The rear of the skid plate is attached with custom manufactured threaded aluminum pins. These pins replace the OEM center stand mounting pins. This design is unique in that it prevents impact forces from being transferred to the motor itself.

The design of the skid plate and mounting method also serve to maintain the large ground clearance of the BMW R 1200 GS motorcycle. The flat-bottomed design allows the skid plate to remain relatively thin and provide significant protection. The mounting design allows the skid plate to remain close to the bottom of the motorcycle. This particular feature maintains the off-road capability of the motorcycle and also serves to further diminish the possibility of obstacles contacting the motorcycle.

### BRIEF DESCRIPTION OF THE DRAWING FIGURES

In order that the invention can be more readily understood, I will describe, by way of illustration, and in relation to the accompanying drawings, the two components of this invention including the stainless steel brackets and aluminum skid plate, along with accompanying hardware and mounting methods.

In these drawings:

FIG. 1 shows an exploded view of the aluminum skid plate, including the mounting brackets and mounting hardware.

FIG. 2 shows a drawing of a 2013+ BMW R 1200 GS motorcycle, including mounting locations of the aluminum skid plate and hardware.

### DETAILED DESCRIPTION OF THE DRAWING FIGURES

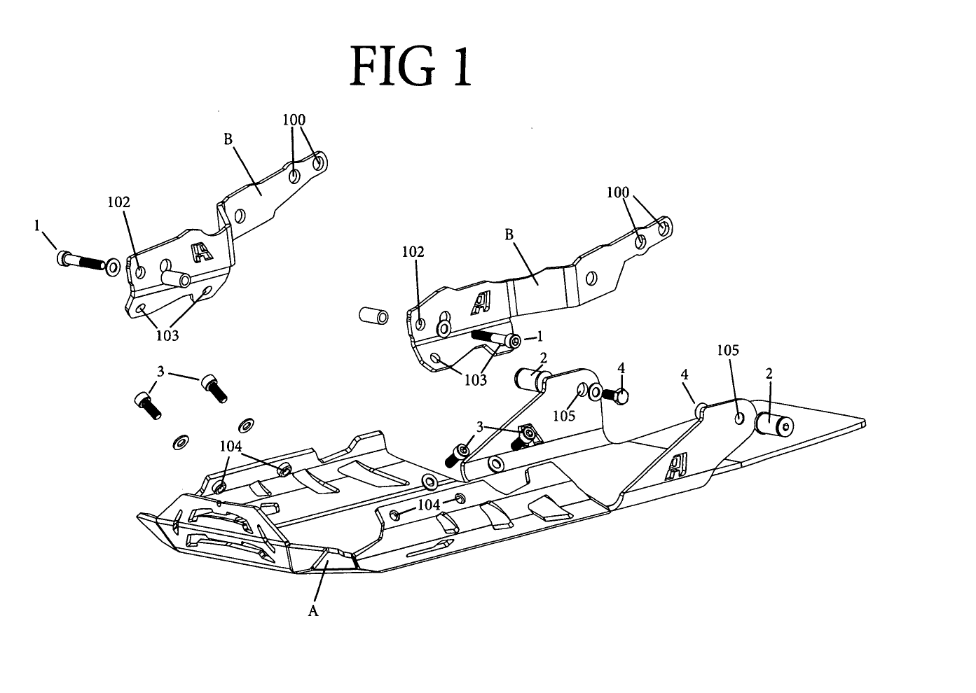

As shown in FIG. 1, the aluminum skid plate consists of the main body A, stainless steel brackets B, and all mounting hardware. The main body A is manufactured from 3/16″ anodized aluminum. The brackets B are constructed from 3/16″ stainless steel.

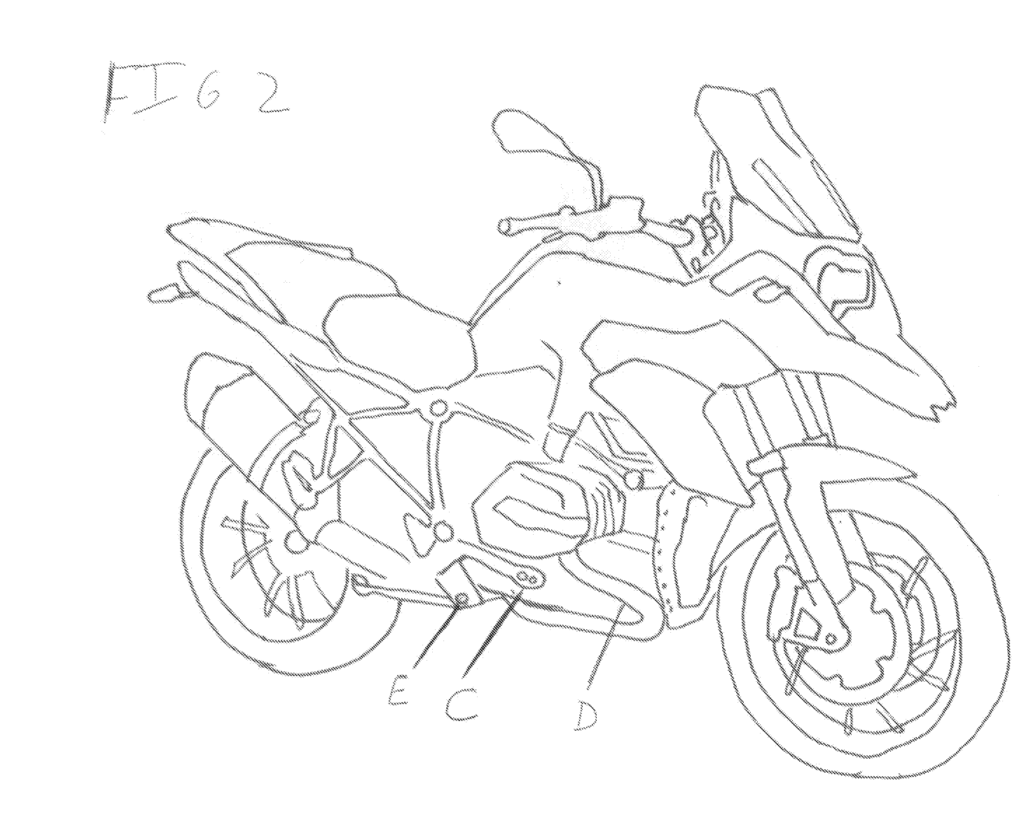

Stainless steel brackets B are attached to the frame of the motorcycle using OEM hardware in holes 100 (see also FIG. 2). Socket cap bolt, washer and spacer 1 utilize hole 102 and thread into the front of the engine block. After stainless steel brackets B are secured, custom threaded aluminum mounting pins 2 replace OEM center stand mounting pins. Main body A is then attached to stainless steel brackets B in the following manner: socket cap bolts and washers 3 utilize hole 103 on stainless steel brackets B and thread into hole 104 on main body A, hex bolt and washer 4 utilize hole 105 and thread into custom threaded aluminum pins 2.

As shown in FIG. 2 the stainless steel brackets B from FIG. 1 mount to the frame spar C and engine block D. The custom threaded aluminum mounting pins 2 from FIG. 1 utilize the center stand mounting location E by replacing the OEM center stand mounting hardware. Though FIG. 2 only shows one side of the BMW R 1200 GS motorcycle, the opposite side mounts in the exact same manner.

I claim:

1. A protection system for the 2013 to current BMW R 1200 GS (internal BMW model number K50) motorcycle comprising:
a. Aluminum skid plate of the design in FIG. 1. and mounted in the manner stated above

2. Mounting methods as described in claim 1
a. Stainless steel brackets that mount to the frame of the BMW R 1200 GS motorcycle and not the motor in the rear
b. Threaded aluminum pins to replace OEM center stand mounting pins
c. A mounting method that isolates the motor from forces generated by an impact to the skid plate
d. A mounting method that seeks to maintain the ground clearance of the BMW R 1200 GS motorcycle

3. Aluminum skid plate as described in claim 1
a. 3/16″ aluminum skid plate in an anodized finish
b. Flat bottom design to maintain to ground clearance
c. Coverage from front of the motor to within 4″ of rear tire, when measured with motorcycle resting on center stand
d. Side to side coverage wide enough to exhaust headers from direct hits from below
